(19) United States
(12) Patent Application Publication
(10) Pub. No.: US 2025/0045847 A1
(43) Pub. Date: Feb. 6, 2025

(54) Systems and Methods for Automating Access

(71) Applicant: Eaigle Inc., Markham (CA)

(72) Inventors: Mahdi MARSOUSI, Maple (CA); Amir HOSSEIN, North York (CA); Bharath SEKAR, Thornhill (CA); Akshaya MISHRA, Whitby (CA)

(73) Assignee: Eaigle Inc., Markham (CA)

(21) Appl. No.: 18/734,898

(22) Filed: Jun. 5, 2024

Related U.S. Application Data
(60) Provisional application No. 63/529,893, filed on Jul. 31, 2023.

(51) Int. Cl. G06Q 50/10; G06V 20/54; G07C 9/00

(52) U.S. Cl. CPC G06Q 50/10; G06V 20/54; G07C 9/00896; G06Q 2240/00; G06V 2201/08

(57) ABSTRACT

The disclosure relates to a method, system, and memory for automating vehicle ingress or egress. Illustratively, the method includes receiving images of a vehicle from imaging devices, and processing the images with an automation system. The processing includes determining one or more properties associated with the vehicle, and receiving a data file based on an interaction between a driver and an input terminal in communication with the automation system. The method includes generating a check-in event, and validating the check-in event based on properties associated with the vehicle. The method includes determining a destination of the vehicle based on the validated check-in event, and generating a guidance data file that comprises path guidance from a location of the vehicle to the determined destination, the guidance data file generating visual elements to indicate the destination once executed by a device associated with the vehicle.

### CROSS REFERENCE TO RELATED APPLICATIONS

This application claims priority to U.S. Provisional Patent Application No. 63/529,893 filed on Jul. 31, 2023, the contents of which are incorporated herein by reference in their entirety.

### TECHNICAL FIELD

This application relates to systems for automating access, and in particular to automating access based on input from an imaging sensor.

### BACKGROUND

The smooth operation of entry and exit gates at logistics facilities, ports, and other establishments is crucial for ensuring efficient handling of incoming and outgoing vehicles, particularly trucks and trailers. However, the current manual check-in and check-out procedures often lead to delays and inefficiencies. Existing procedures are lacking. Some existing procedures suffer from errors, can have poor accuracy, poor data validation, involve time-consuming processes, labor inefficiencies, all of which can hamper overall operational productivity or allow unauthorized entry or refuse authorized entry or exit.

Presently, entry and exit gate automation systems predominantly depend manual registry of vehicle as well as tracking technologies such as wireless sensor networks (WSN), radio frequency identification (RFID), swipe cards, and preliminary computer vision systems such as license plate recognition. These systems involve multiple components, including transmitters, receivers, and a multitude of RFIDs, necessitating the installation of these parts on each vehicle. Other than the cost associated with the hardware, the process of maintaining (e.g., tagging and un-tagging) and setting up these system is time and labor intensive.

Some existing systems rely on automated license plate recognition technology. However, these existing systems don't automate the access processes to a sufficient process, or require unacceptable security tradeoffs (e.g., the driver information is not verified), and more generally are under developed and can require a significant amount of human involvement to paper over implementational challenges.

### SUMMARY

In one aspect, a method for automating vehicle ingress or egress is disclosed. The method includes receiving a plurality of images of a vehicle from one or more imaging devices, and processing the plurality of images with an automation system. The processing includes, with a machine vision model of the automation system, determining one or more properties associated with the vehicle, and receiving a data file based on an interaction between a driver and an input terminal in communication with the automation system. The processing includes processing the data file with the automation system by, generating a check-in event, and with a machine learning model, validating the check-in event based at least in part on the one or more properties associated with the vehicle. The method includes determining a destination of the vehicle based on the validated check-in event, and generating a guidance data file that comprises path guidance from a location of the vehicle to the determined destination, the guidance data file generating visual elements to indicate the destination once executed by a device associated with the vehicle.

The method can include, in response to validating the check-in event, instructing a gate to permit entry or egress to the vehicle.

The method can include, with the machine vision model, generating a three-dimensional model of the vehicle, receiving a second set of images from the one or more imaging devices. The method can include, with the machine vision model, generating a second three-dimensional model of the vehicle based on the second set of images, and generating an estimate of damage to the vehicle incurred for a duration between the plurality of images and the second set of images.

In example embodiments, the guidance data file comprises generated visual elements that overlay onto existing mapping applications.

In example embodiments, the data file includes an image of identification of the driver, and the method can include with a machine vision model of the automation system, determining one or more properties of the identification from the image. The validation of the check-in event can be at least in part based on the determined one or more properties of the identification.

The method can include, with an interface of the automation system, retrieving existing information related to the vehicle or driver from a yard management system. The destination can be determined based on the existing information.

The method can include, with the machine vision model, generating a three-dimensional model of the vehicle, and determining one or more properties associated with the vehicle based on the three-dimensional model of the vehicle.

The method can include receiving a plurality of images for a plurality of vehicles and processing the plurality of images with the automation system to determine optimal paths for the plurality of vehicles to respective destinations or to gates for ingress or egress.

The method can include, in response to not receiving input from a sensor used to detect vehicles, stopping processing of the plurality of images by the automation system.

The method can include receiving a second set of images of the vehicle from the one or more imaging devices. The method can include, with the machine vision model, at least in part determining a presence of the vehicle in the second set of images, determining a duration the vehicle spent inside a region based on the plurality of images and the second set of images, and generating an invoice based on the determined duration.

In another aspect, a system for automating vehicle ingress or egress is disclosed. The system includes one or more imaging devices, a processor, and a memory in communication with the processor. The memory stores computer executable instructions that cause the processor to receive a plurality of images of a vehicle from one or more imaging devices, and processing the plurality of images with an automation system. The instructions cause the processor to, with a machine vision model of the automation system, determine one or more properties associated with the vehicle, and receiving a data file based on an interaction between a driver and an input terminal in communication with the automation system. The instructions cause the processor to process the data file with the automation system by, generating a check-in event, and with a machine learning model, validating the check-in event based at least in part on the one or more properties associated with the vehicle. The instructions cause the processor to determine a destination of the vehicle based on the validated check-in event, and generating a guidance data file that comprises path guidance from a location of the vehicle to the determined destination, the guidance data file generating visual elements to indicate the destination once executed by a device associated with the vehicle.

The computer executable instructions can cause the processor to, in response to validating the check-in event, instruct a gate to permit entry or egress to the vehicle.

The computer executable instructions can cause the processor to, with the machine vision model, generate a three-dimensional model of the vehicle, and receive a second set of images from the one or more imaging devices. The computer executable instructions can cause the processor to, with the machine vision model, generate a second three-dimensional model of the vehicle based on the second set of images, and generate an estimate of damage to the vehicle incurred for a duration between the plurality of images and the second set of images.

The guidance data file can include generated visual elements that overlay onto existing mapping applications.

The data file can include an image of identification of the driver, and the computer executable instructions can cause the processor to, with a machine vision model of the automation system, determine one or more properties of the identification from the image. The validation of the check-in event can be at least in part based on the determined one or more properties of the identification.

The computer executable instructions can cause the processor to, with an interface of the automation system, retrieve existing information related to the vehicle or driver from a yard management system. The destination can be determined based on the existing information.

The computer executable instructions can cause the processor to, with the machine vision model, generate a three-dimensional model of the vehicle, and determine one or more properties associated with the vehicle based on the three-dimensional model of the vehicle.

In another aspect, a non-transitory computer readable medium (CRM) for cryptographic communications is disclosed. The CRM includes computer executable instructions that, when executed by a processor, cause the processor to perform any one of the methods described above.

### BRIEF DESCRIPTION OF THE DRAWINGS

Embodiments will now be described with reference to the appended drawings wherein:

FIG. 1 is a diagram of an example region and automation system.

FIG. 2A is a schematic diagram of an example system for at least in part automating entry and exit.

FIG. 2B is a schematic diagram of another example system for at least in part automating entry and exit.

FIG. 3 is a schematic diagram of an example automation system.

FIG. 4 is a block diagram of an example workflow for automated entry and exit.

FIG. 5 provides a flow diagram of an example method for operating a gate.

FIG. 6 provides a flow diagram of another example method for operating a gate.

FIG. 7 provides a flow diagram of yet another example method for operating a gate.

FIG. 8 provides a flow diagram of yet another example method for operating a gate.

### DETAILED DESCRIPTION

Described herein is an approach to automated, or at least in part automated gateway control and/or region logistics. As used herein, the term “logistics” captures movement of people, vehicles, goods, etc., though, around, or within a region. It is understood that the term region is not limited to enclosed spaces, and can include outdoor spaces such as parking lots. For example, it is understood that the term region captures a drop-off and delivery portion of a region, whether completely fenced in or not.

Existing inbound and outbound traffic technologies at warehouses, distribution centers, ports, terminals, gates, logistics facilities, etc., are deficient.

The smooth operation of entry and exit gates at logistics facilities, ports, and other establishments is crucial for ensuring efficient handling of incoming and outgoing vehicles, particularly trucks and trailers. However, the current manual check-in and check-out procedures often lead to delays and inefficiencies. Relying on human intervention in current procedures which is based on conventional methods results in errors, lack of data accuracy and data validation, time-consuming processes, labor inefficiencies and hampering overall operational productivity. Consequently, there arises a pressing need for an automated and intelligent solution that can enhance the efficiency of logistics in/outbound and gate operations.

Presently, entry and exit gate automation systems predominantly depend manual registry of vehicle as well as tracking technologies such as wireless sensor networks (WSN), radio frequency identification (RFID), swipe cards, and preliminary computer vision systems such as license plate recognition. These systems involve multiple components, including transmitters, receivers, and a multitude of RFIDs, necessitating the installation of these parts on each vehicle. Other than the costs associated with the sensors, the process of tagging and un-tagging is time and labor intensive.

Moreover, these existing sensors fail to provide comprehensive coverage of the physical appearance of vehicles and the region premises. Consequently, the inability to monitor the vehicle's condition while inside the region makes it challenging to identify damages that may have occurred during the vehicle's stay, thus hindering efficient damage control and management.

License plate recognition technology has been used for automated vehicle access in certain applications, allowing authorized vehicles to pass through access points without the need for physical interaction. However, these systems don't automate the total in/outbound registry processes, are under developed and still require a significant amount of human involvement.

Moreover, these existing approaches fail to provide comprehensive coverage of the physical appearance of vehicles and the region premises. Consequently, the inability to monitor the vehicle's condition while inside the region makes it challenging to identify damages that may have occurred during the vehicle's stay, thus hindering efficient damage control and management.

This disclosure relates to at least in part automated ingress/egress. Illustratively, an example system receives single or multiple images from one or more imaging sensors either directly from imaging sensors or through a video management software (VMS) system. The example system can integrate to and gather information from various types of sensors, such as wireless sensors and radio frequency identification (RFID) based technology, etc. The system is designed to utilize an in-house human-computer interaction (HCl) kiosk. The example system can be flexible, and can, for example, be integrated with existing yard management software (YMS), kiosks and other systems.

In at least one aspect, the disclosed system may streamline the check-in and check-out processes by introducing a cohesive and intelligent solution by combining advanced machine learning, artificial intelligence and automation methods and technologies. Automation technologies related to artificial intelligence, deep learning, text processing, and computer vision technologies can be integrated into the example system. The disclosed process can automatically obtain license plate numbers, truck, trailer, and chassis numbers, company logos, and any other essential textual information, and/or unique identifiers, camera calibration, human-computer interaction, map-guided navigations, and defect detections.

Vehicle throughput may potentially be increased, labor and waiting times can potentially be reduced, and security can be more effective as measures to more effectively monitor vehicles and the region premises.

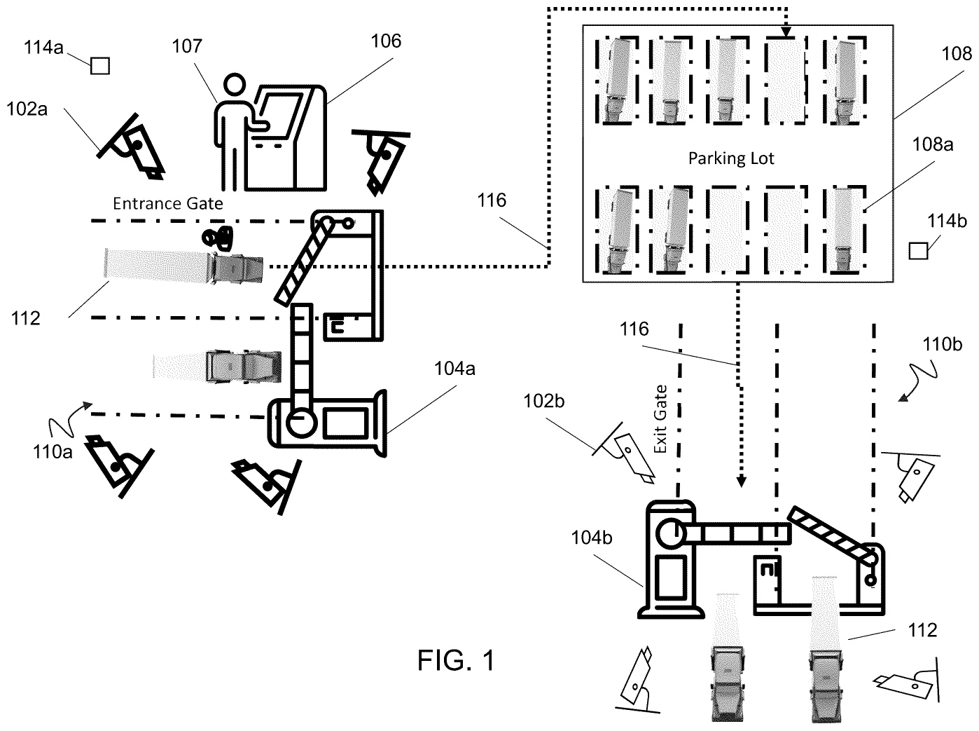

Referring now to the figures, FIG. 1 shows an example system that automates entities entering and/or exiting a region 100. In the shown embodiment, the region 100 includes, or within the field of view of (e.g., via a third-party hardware provider) one or more imaging devices 102 (where only imaging devices 102a, 102b, are labelled, for visual clarity). The imaging devices 102 (referred to solely in the plural, for ease of reference) can include a wireless imaging device, a wired imaging device, a standalone imaging device, a multi-purpose imaging device (e.g., the device 102 can include a camera and one or more other sensors in the same housing), etc. The imaging devices 102 can have a field of vision that includes only one gate (as that term is used herein), or an imaging device can have a field of vision that includes more than one gate, or each imaging device can have a field of vision that includes the entire region, or an imaging device of the imaging devices can have a field of view that does not include a gate, but does cover at least some of the region 100. The imaging devices 102 can include other than images in the visible spectrum, such as infrared imaging devices, etc.

The region 100 includes one or more access control devices 104 (referred to solely in the plural, for ease of reference). For example, the shown embodiment includes both the inbound access control device 104a and the outbound access control device 104b. It is understood the reference to ingress and egress is merely illustrative; the same access control device 104 can allow both ingress and egress. The access control devices 104 are intended to prevent other than authorized ingress/egress to the region 100. For example, the access control device 104 can be a so-called rising arm gate, as shown, or it can be a bollard, or a moveable portion of fencing, a gate, etc.

The region 100 can optionally include one or more input terminals 106 (referred to solely in the plural, for ease of reference). The input terminals 106 can include one or more means for receiving input from a user, shown illustratively as user 107. The input means can include a keyboard, mouse, touch screen, auditory means (e.g., a chat-based input system), etc. The input terminals 106 can also be connected to one or more operators for live communication with an employee, agent, etc., responsible for managing the region 100. For example, the input terminal 106 can participate in an intercom system.

In at least one example embodiment, the terminals 106 provide a human-computer interaction layer and enable a user 107 to enter their relevant information (e.g., a driver's license, vehicle information, vehicle content information), and receive displaying information to guide the user 107 and vehicle 112 to the determined destination 108 (as described herein).

The region 100 includes one or more destinations 108. For example, in the shown embodiment, the region 100 includes a parking lot, which parking lot destination 108 can include one or more partitions (e.g., the shown parking spot 108a, where only one parking spot is labelled for visual clarity).

For ease of reference, the imaging device 102a, access control device 104a, and the input terminal 106 can be referred to collectively as the “inbound gate”. Similarly, the imaging device 102b and the access control device 104b can be referred to collectively as the “outbound gate.”

The region 100 can optionally include one or more designated pathways 116 or more generally routes 110 for moving people, goods, or materials (e.g., as demonstrated by the shown truck 112) between the destination(s) 108 and the inbound or outbound gates. The designated pathways 116 can include street lanes, or can include rail lines, trails, etc. Different designated pathways 116 can be used for ingress and egress, or pathways 116 can be used to serve movement to and from one or both of the ingress and egress gates.

The region 100 can also include one or more sensors 114. Various types of sensors, and various numbers of sensors are contemplated. For example, the sensors 114 can be light sensors, such as LiDAR sensor or infrared sensors, or piezoelectric sensors that are triggered based on pressure, etc. The sensors 114 can be installed, positioned, calibrated, etc., to determine the presence of an object within or outside the region 100. For example, the sensor 114 can be an infrared sensor (e.g., the shown sensor 114a) that is used to detect trucks approaching the ingress gate, which trucks may be outside the field of view of the imaging devices 102. In another example, the sensor 114b can be a motion sensor that determines whether a truck is moving after having been parked for some time.

It is understood that FIG. 1 shows a relatively simplified system having only one inbound and outbound gate and related pathways 116, and that more complex systems are contemplated. For example, the region 100 can include a plurality of gates which can alternate between being ingress and egress gates, and a plurality of pathways 116, etc.

Each of the shown imaging devices 102, access control devices 104, and input terminals 106, and/or, optionally, sensors 114 (hereinafter referred to in the alternative as the “Devices,” for ease of reference) can be connected to wireless or wired network (not shown). The Devices can all be connected to the same network, or some of the Devices can be connected to one network while others are connected to another network. Each of the Devices can provide at least some information related to entities which enter or exit the region 100. For example, the imaging devices 102 can provide live digital images of the region within their field of view, the access control devices 104 can provide their status, the input terminals can generate digital representations of the input data (e.g., a form), or recordings, etc.

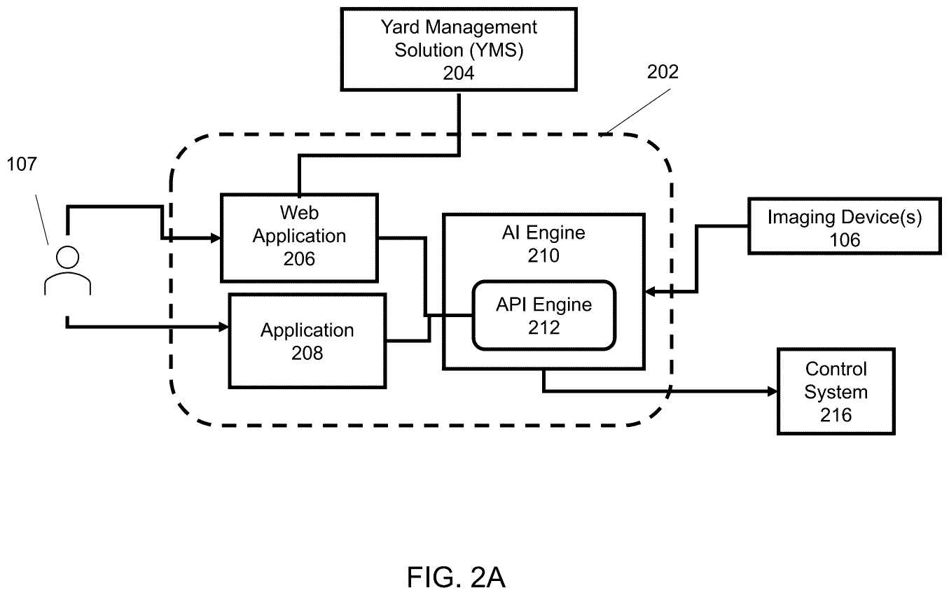

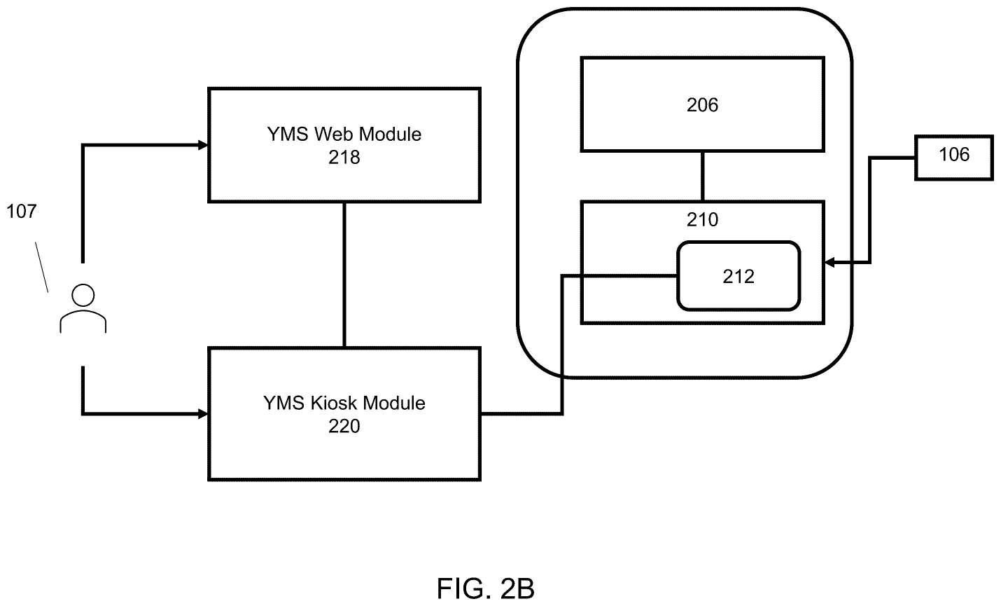

Referring now to FIG. 2A, a schematic diagram of an example system for at least in part automating entry and exit is shown. In FIG. 2A, an automation system 202 is at least in part used to either process information received (directly or indirectly) from the Devices, or to control one or more of the Devices (e.g., directly, or indirectly via, for example, a control system 216). In the shown embodiment, the automation system 202 includes components to enable users 107 to directly interact with the automation system 202. For example, the user 107 can access a web application 206 hosted by the operator of the automation system 202 (and illustratively shown as part of the automation system 202) to enter information used by the automation system 202 in determining and tracking entry and exits. The web application 206 can, for example, provide a cloud API to store analytics and depersonalized data (e.g., stored in a relational database format). The user 107 can also interact with the automation system 202 directly via an application 208, which application can be an application that manages access control devices 104.

The automation system 202 can be configured to enable direct communication with a third-party yard management solution (YMS) 204, or a third party transportation management system (TMS). This can be helpful where the region in issue has existing yard management solutions, or the enterprise has an existing TMS that it relies on, and wants to use advanced automatic vehicle control features. For example, in the shown embodiment, the YMS 204 includes an application programming interface (API) for communicating with the automation system 202. Communication can include receiving information (e.g., approval of entry), or communicating information to the YMS (e.g., providing user 107 entered information). A similar API, not shown, can be configured for the TMS, or the API serving communication between the YMS 204 and the automation system 202 can be configured to also handle communication between a TMS and the automation system. The TMS can similarly provide information relevant to the automation system 202, such as an expected arrival time which can trigger the automation system 202 imaging devices to activate, or to provide reference data such as an expected driver, bill of lading, etc.

The automation system 202 includes an artificial intelligence (AI) module 210 for at least one of (1) determining whether to permit or deny entry/exit, (2) determine whether imaging information coincides with submitted information, (3) determining if and when damage has occurred to any entity entering or exiting the region, etc. For clarity, the AI module 210 can determine one, or more than one, in various combinations, of the aspects described above.

The AI module 210 can encompass one or more of any one of a neural network-based object detection, tracking, instance segmentation, classification, full 360 reconstruction, and damage verification through 3D matching model. The AI module 210 can include, for example, deep learning-based neural networks for efficient object recognition, segmentation, and classification. The AI module 210 can employ a simultaneous localization and mapping method to detect and track vehicles over multiple frames using optimal number of imaging sensors. The AI module 210 can generate a 360 full view vehicle reconstruction utilizing a combination of imaging devices 102 and reconstruction methods. The AI module 210 can create a comprehensive 360-degree view of the vehicle's surroundings. For clarity, the AI module 210 can include a plurality of neural networks that are separately trained for different tasks. For example, the AI module 210 can include a first model for object detection, another for object tracking, another for classification, etc. Or, in another example, a single model can complete a variety of tasks (e.g., tracking and classification). Using different models for different tasks can facilitate modularization, and make updating easier (e.g., a revised tracking model can be implemented without requiring testing of all aspects of a one-size-fits-all model).

The AI module 210 can receive data directly from an imaging device software development kit (SDK) or via a video management systems (VMS), etc. The AI module 210 can be used to estimate the optimal number of imaging devices 102, and/or optimal locations of the imaging devices 102 to cover a defined region 100, a gate, etc. Similarly, the AI module 210 can be used to determine imaging device 102 calibration (e.g., focus, etc.).

The AI module 210 can also be used to determine controls for one or more of the Devices. For example, the AI module can determine that entry is permitted to a vehicle 112 entering the region 100, and cause the access control device 104 to open. Similarly, the AI module 210 can determine that there is an issue with one of the imaging devices 102, and control the access control device 104 to close. Various actions are contemplated.

The AI module 210 (or a model therein) can be used for semi-automatic region drawing and lane assignment. For example, the AI module 210 can be used to draw regions of interest in images generated by the imaging devices 102 (e.g., assigning lanes), providing templates for calibrating vehicle 112 imaging sensors, etc. This can be useful for autonomous driving and advanced driver assistance systems.

The AI module 210 can include an API engine 212, to facilitate ingestion of the data from different sources, or to facilitate providing data for third party systems. For example, the API engine 212 can be used to process incoming imaging information from the imaging devices 102. The API engine can format entered data into one or more formats (e.g., input data can be formatted into a particular array) as expected by the AI module, or partitions (e.g., input imaging data can be provided in subsets), etc. In an example, the API engine 212 can provide restful application programming interfaces (APIs) such that external devices can communicate with the AI engine 210, including, but not limited to, the following calls: get annotated image, get occupancy heatmap, get object detection details, get vehicle text recognition output, get tracking details, add imaging sensors details, and set imaging sensors region of interest (ROI).

The API engine 212 can be used to format input data into a format accepted by the YMS. For example, data input into the terminal 106 (alternatively referred to herein as kiosks) can be converted to be entered and stored by the YMS system.

The API engine 212 can be used for communication with the Devices, and integrate inputs or outputs from the Devices into the terminal 106, as part of an AI driven process, such as a driver license verification process, etc. The API engine 212 can be used to deliver information directly to a driver of a vehicle 112. For example, the API engine 212 can be configured to communicate with a computing device of the driver/vehicle 112 (e.g., a cell phone, or specialized hardware used in the trucking industry that displays maps and/or trajectories) to provide a visual mapping (e.g., the suggested pathway 116 of FIG. 1) of directions to designated destination 108.

FIG. 2B shows another example embodiment, where information from the user 107 is received by the automation system 202 via a YMS web application 218 or kiosk module 220 operated by the YMS.

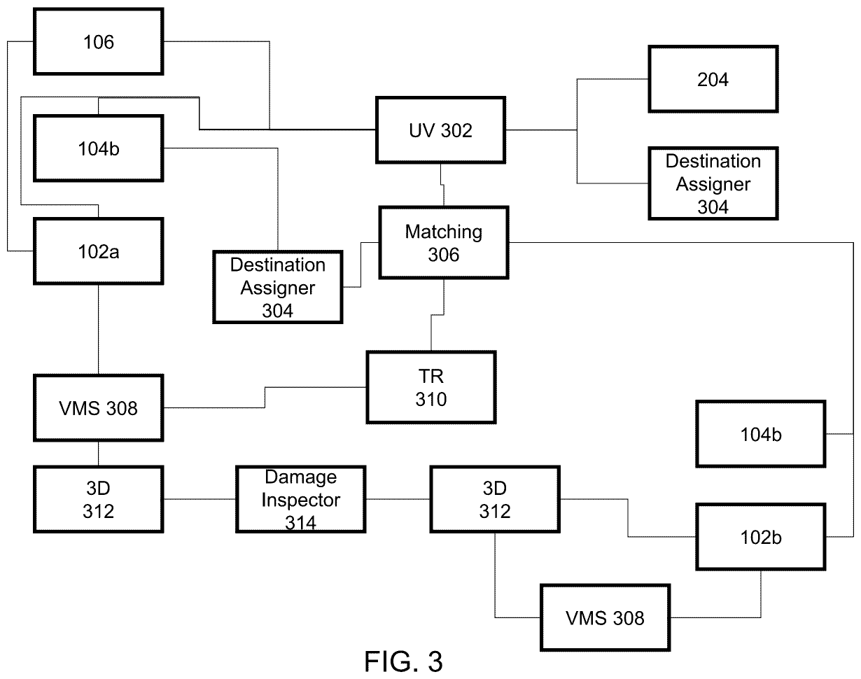

FIG. 3 shows a block diagram of an example framework for at least in part automating exit and/or entry. In FIG. 3, information provided to the input terminal 106 can include details of the user 107 entering information into the terminal 106, such as a driver of a vehicle or a delivery person. In at least one contemplated embodiment, the user 107 can enter the information to the terminal 106 via an imaging device of the terminal 106. For example, the terminal 106 can include an image capture device (e.g., similar to the devices 102 described herein), and the user 107 can be required (or may optionally) hold their driver's license of other identifying information in the field of view of the terminal 106 imaging device. The terminal 106 can also rely on communication with imaging device(s) 102a to receive the image of the identifying information.

The automation system 202 can process the identify verification information (e.g., an image, or information entered by the user 107) provided by the user 107 via the user verification module 302. The user verification module 302 be an aspect of the automation system 202 (e.g., a model within the AI module 210), and can be trained to determine if the entered user 107 information is accurate, corresponds to expected information, satisfies certain criteria, etc.

To assess accuracy of the information entered, the user verification module 302 can compare the provided information with known formats of drivers' licenses. For example, the user verification module 302 can include pre-defined information (e.g., driver's license number length, position of letter characters, etc.) about drivers licenses issued by various states or countries, and determine if the provided information coincides with known format requirements. If the input terminal 106 or an imaging device 102 is configured to provide an image to the user verification module 302, the module can verify whether the provided identifying information is accurate at least in part by comparing visual indicators of the user 107 or provided identity information. For example, the user verification module 302 can assess whether the format of the provided driver's license is accurate for the purported issuing jurisdiction. The user verification module 302 can compare a captured image of the user 107 with an image of the user 107 provided on the identifying information, compare the image(s) of the user 107 with previously stored images or feature vector (e.g., the automation system 202 can be configured to capture visual information of a user in a feature vector of the user to enable comparison) of the user.

To determine if the provided information corresponds to expected information, the user verification module 302 can be configured to access one or more datastores (not shown) which include expected information. For example, the user 107 can be an employee of a logistics provider, and the provider may be required to provide identifying information (e.g., invoice number, contract number, identifying information specifically generated for automated entry, etc.) to automate access.

The provided information (or circumstances surrounding the provided information) can also be assessed to determine whether it satisfies certain criteria. The criteria can include, for example, whether the time and date of the requested access coincides with expected time for requesting access, whether the information is provided in an expected manner (e.g., where a user 107 typically shows a first kind of identification, the use of another kind of identification can fail a consistency criteria), the location and circumstances of the provided information (e.g., the driver is driving for a new logistics provider, the driver is in a route that is unusual, the driver had a check-in at a location that is physically impossible to access in time to perform the check-in at this time), etc.

In certain example embodiments, the external YMS API 204 is connected to the user verification module 302, and coordinates with the user verification module 302 to verify the provided information. For example, the YMS 204 can store user identifying information that can be used to determine whether the provided information is accurate (e.g., the logistics provider may have been required to provide user 107 identifying information prior to the user 107 being dispatched to the region), have other than government issued identifying information for use in user verification (e.g., an employee number, or an invoice number the user 107 is expected to provide, etc.), or can be provide real-time input (e.g., an operator can confirm the identity of the driver), etc.

The YMS 204 can communicate with the automation system 202 to determine a destination 118, as shown by the destination assigner 304. For example, the YMS 204 can provide a zone where the logistics is required for offloading, and the automation system 202 can provide a more granular assignment based on current conditions gleaned from the imaging devices 102.

In FIG. 3, once the user 107 identifying information is verified, the combination of the vehicle used by the user 107 to access the region and the user 107 can be verified. The matching can include retrieving information from the imaging devices 102 directly, or indirectly, e.g., through the shown video management system (VMS) 308. Imaging information from the VMS 308 can be provided to one aspect of the automation system 202 trained to read text from vehicle. For example, the aspect can be the shown text reader (TR) 310, which can read text on the vehicle such as trailer VIN numbers, trailer identifying number, or other identifying information

Imaging from the imaging device(s) 102 can be used to generate a three-dimensional reconstruction of the vehicle at the gate. The automation system 202 can include a plurality of statistical models (e.g., a first model to identify the type of vehicle, subsequent models to construct the specific type of identified vehicle, etc.) that are used to reconstruct a three (3) dimensional creation of the vehicle from the two (2) dimensional images from the imaging device(s) 102. In the shown embodiment, a 3D model of the vehicle at the gate is generated at block 312.

The automation system 202 can assess images of the user 107 captured by the imaging devices 102 and compare them to the provided identification information to determine if the information is accurate.

At block 312, as alluded to above, 3D reconstruction of the vehicle can be generated. The reconstruction can be generated at ingress, egress, or at any time the vehicle is within the region. The reconstructions can be generated based on a plurality of images, with at least two images from two different imaging devices 102. In the embodiment shown in FIG. 1, for example, each of the ingress and egress have multiple imaging devices 102 having a view of the access control devices 104, to ensure that every vehicle within the region 100 is properly documented with reconstructions. More granular reconstructions are contemplated, with, in an example, a reconstruction being generated at various positions within the region 100.

The reconstructions can be combined with other data and stored by the enterprise or system. For example, the reconstructions can be stored alongside invoices, driver information, other information (e.g., measured vehicle weights), etc.

At block 314, at least two reconstructions from block 312 generated by the AI module 210 are compared to assess damage. For example, the reconstruction at ingress and egress can be compared to determine damage that occurred in the duration between images. The AI module 210 can be used to generate indicators of the difference (e.g., masks) on the stored images, to enable rapid review. In certain logistics applications, it is not uncommon for a carrier to allege damage within a region 100, and having 3D imaging of ingress and egress conditions can desirably reduce disputes, or facilitate payouts from insurers, etc.

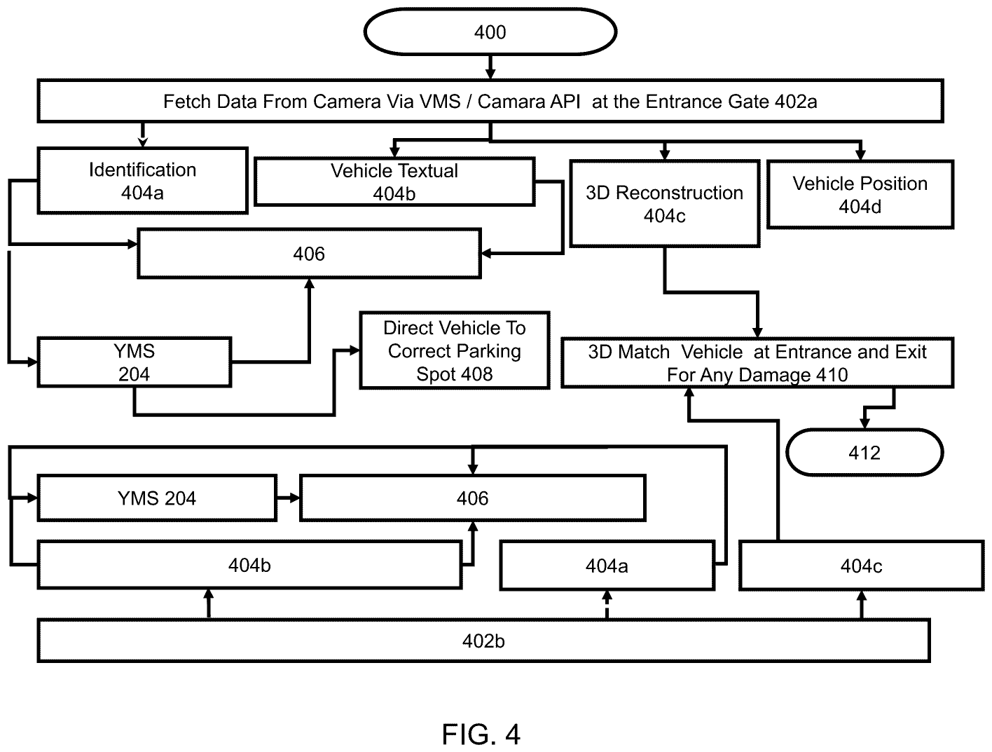

Referring now to FIG. 4, a block diagram of an example workflow for automated entry and exit is shown.

At block 400, the workflow begins. The workflow can begin, for example, based on a sensor 114 determining the presence of a vehicle 112. The workflow can be configured to start only upon detection of the vehicle 112 by the sensor 114 (e.g., a low cost, or low operational cost sensor), to avoid the expense (e.g., server costs) of processing the images with the AI module 210 to determine the presence of a vehicle.

Block 400 can be a continuous monitoring for the arrivals and departures of vehicles 112. For example, the imaging device 102 and/or sensor 114 feeds can continuously communicate to the automation system 202. The areas that are continuously monitored can be remotely configured, e.g., via a region drawing tool and web interface.

At block 402, a plurality of images can be received from the imaging devices 102. In FIG. 4, the example focuses on ingress, and so the blocks shall be discussed with ingress for illustration. It is understood that a person skilled in the art could adapt the method discussed to egress. The plurality of images can be received, or retrieved (e.g., fetched). The images can be received directly, or indirectly, from an API, such as the YMS 204 of FIG. 2.

At block 404a, the AI module 210 can be used to scan and read at least the images of the plurality of images of the identification provided by the user 107. For example, the AI module 210 can be provided a separate image from an input terminal 106 with an imaging device where the user 107 is required to hold the identification in a particular position or configuration. The AI module 210 can also process images from the imaging devices 102, and the user 107 can be instructed to hold the identification towards a particular imaging device 102, etc.

At block 404b, the plurality of images can be processed to determine one or more properties of the vehicle 112. The one or more properties can include any numbering painted, etched, written, etc., on the vehicle or an accessory vehicle (e.g., a trailer, and hereinafter referred to generally as a vehicle, for ease of reference) that is visible to the imaging devices 102. In instances where multiple vehicles 112 pass through the field of view of the imaging device 102, the imaging devices 102 can be configured to determine one or more properties of each vehicle 112.

At block 404c, the AI module 210 can generate a 3D (e.g., a 360 degree) reconstruction of the vehicle 112 passing through the gate. In instances where multiple vehicles 112 pass through the field of view of the imaging device 102, the imaging devices 102 can be configured to generate 2D reconstructions of each vehicle 112.

At block 404d, a vehicle 112 position is estimated. The estimate can be generated by the AI module 210. The position can include a pathway 116, such as a lane number, or a more precise position.

As indicated by the numbering, each of steps 404 can be completed individually, in any of a variety of combinations, or simultaneously. For example, the AI module 210 can process the images for the user 107 identification separately from the images related to the vehicles.

At block 406, the information from blocks 404a and 404b validated. That is, the AI module 210 can match the driver information, the vehicle information, to known information. For example, block 406 can include the AI module 210 determining, based on logistics information from the YMS 204, that the driver is the expected driver. Similarly, block 406 can include the text information from block 404b being matched to existing manifests.

At block 408, the AI module 210 can be used to determine a destination 108 for the vehicle 112. The destination 108 can be selected based on traffic conditions of the region 100 as determined by the AI module 210, based on previous assignments to destinations 108, etc. For example, the AI module 210 can review a plurality of images from a plurality of imaging devices 102 including imaging devices 102 that are not focused on ingress and egress, and determine the destination 108.

Block 408 can include determining a designated pathway (e.g., pathway 116 of FIG. 1) for the vehicle 112.

The AI module 210 can determine the destination 108 and designated pathway individually, in sequence (e.g., determine destination 108 first, determine designated pathway based on destination 108), or simultaneously. For example, the AI module 210 can be trained to determine the destination 108 that is closest to a cargo bay, determine a destination based on a fastest travel designated pathway, etc.

As is shown on the bottom half of FIG. 4, a similar process can be conducted when a vehicle 112 is at an exit gate, other than the need to determine a destination/designated path.

At block 410, 3D reconstructions from the ingress gate and egress gate can be compared with an aspect of the AI module 210. Block 410 can involve determining any damage to the vehicle 112 between the two reconstructions. For example, portions of the reconstruction that show damage in the later image can be saved, along with the earlier reconstruction, to document the damage.

At block 412, the access control device 104 can be operated to open or close, allowing the vehicle to leave, or preventing the vehicle from moving.

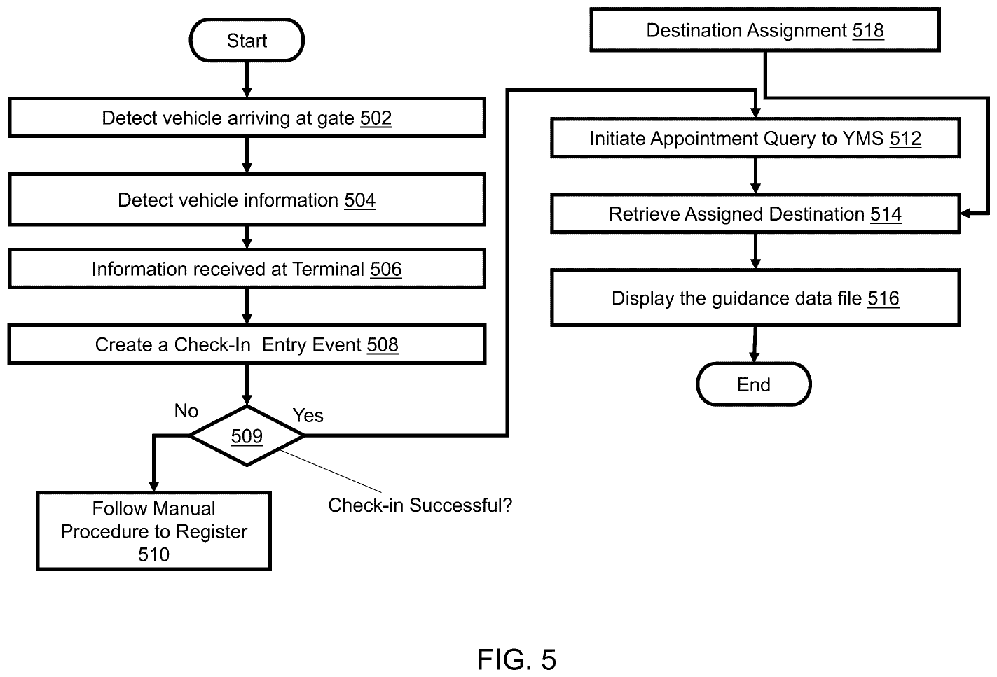

Referring now to FIG. 5, a flow diagram of an example method for operating a gate is shown. FIG. 5 can be a method for operating inbound gate(s) using both the automation system 202 and the input terminal 106.

At block 502, an approaching vehicle can be detected. For example, a vehicle 112 can be detected in images provided by the imaging devices 102. A vehicle 112 can be detected by a sensor 114, to avoid the expense of operating the automation system 202 for the detection task.

In response to detecting the approaching vehicle 112, the automation system 202 can initiate collecting images from the imaging devices 102. To avoid operational expense, the automation system 202 can activate imaging devices 102 in a sequence. For example, the automation system 202 can activate the imaging devices 102 with a field-of-view of the gate upon detecting the vehicle 112 approaching. The automation system 202 can deactivate those imaging devices 102 upon the vehicle 112 passing through the gate, that activate any imaging devices or hundred and 2 that have a field-of-view of the destination 108, etc.

At block 504, the plurality of images collected by the imaging devices 102 can be processed by the automation system 202 to determine information or characteristics associated with the vehicle 112. For example, the information can include a license plate number, a truck and trailer number, logos, etc.

At block 506, a user 107 can be prompted to enter information into the input terminal 106. The input terminal 106 can be within a field-of-view of the driver's window of the vehicle 112, and can display a prompt inviting the user 107 to enter information. A speaker out of the access control device 104 can notify the user 107 that additional information is required to be entered at the input terminal 106, etc.

The user 107 can enter information into the input terminal 106 for consideration by the automation system 202. For example, the user 107 can enter information such as a driver's license, a carrier company associated with the vehicle 112, etc. In at least some example embodiments, the user 107 can be prompted to enter at least some the information expected to be detected in block 504.

At block 508, the automation system 202 collects some or all of the information from blocks 506, 504, and automatically generates a check in event. For example, the automation system 202 can, via training, use the information from blocks 504, 506, to populate a check-in event in a format acceptable to the operator of the region 100, or the YMS 204.

At block 509, a determination is made as to whether the check in event created in block 508 is successful. Success can be determined on whether sufficient amount of information is included in the check-in event. For example, in the event that the detection of block 504 fails to yield a trailer number, a check-in event can be unsuccessful. To provide another example, in the event that the extracted vehicle information, such as truck and trailer number matches with YMS appointment details, the event can be determined to be successful.

In response to an unsuccessful event at block 509, the user 107 can be directed to complete more extensive registration in block 510. More extensive registration above 510 can include providing information via a two-way communication in the input terminal 106, or providing additional information is input to the input terminal 106, etc.

In response to a successful event at block 509, at block 512, the automation system 202 can initiate a query to a yard management system associated with the region.

A block 514, an assigned destination 108 is retrieved. The assigned destination 108 can be retrieved from the YMS 204, or generated by the automation system 202, etc. The assigned destination 108 can be retrieved via a plurality of channels, including an API (as discussed herein), or otherwise.

At block 516, the automation system 202 generates a guidance data file that includes path guidance from the gate to the assigned destination 118 a block 514. The guidance data file can be used to generate visual elements to indicate the destination 118. For example, the guidance data file can include visual elements (e.g., arrows, boxes, etc.) overlaid on top of images from the imaging devices 102 showing the current state of the pathway 116. In another example, the guidance data file can generate visual elements overlayed on top of a map. The guidance data file can include various indicators to facilitate a more intuitive interface, including providing masking overtop of landmarks or other features.

The guidance file can be displayed on a variety of different devices. For example, the guidance file can be overlayed on top of a map or other images displayed on the input terminal 106 for the user's 107 perusal, on a mobile device of the user 107, on a screen associated with the vehicle 112, etc.

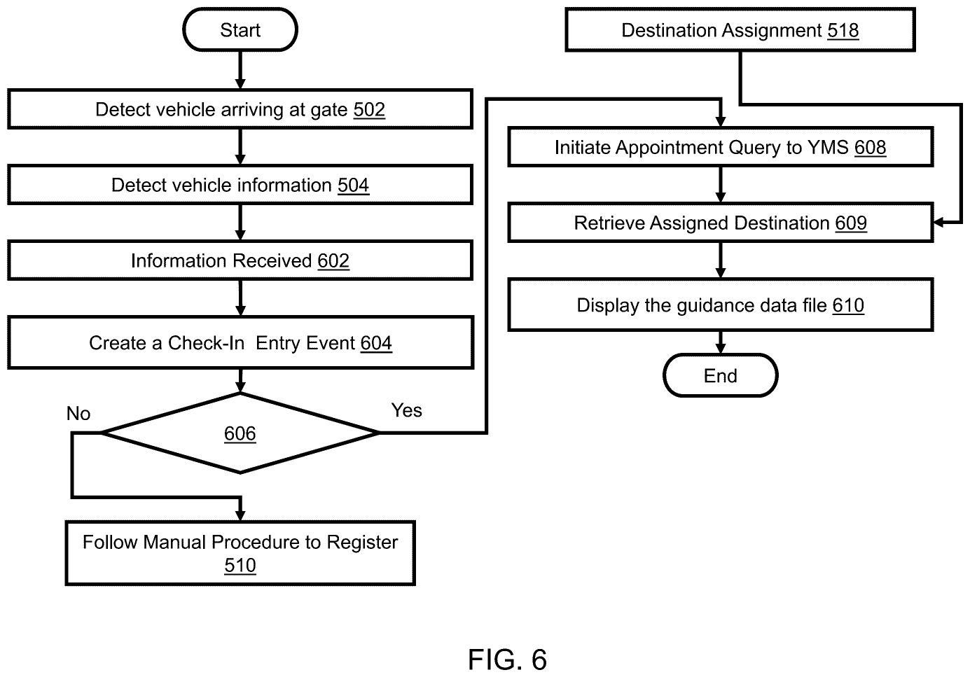

FIG. 6 provides a flow diagram of another example method for operating a gate. In FIG. 6, the input terminal 106 is a terminal managed by a system other than the system managing the automation system 202. For example, the terminal 106 can be a terminal operated by the owner of a region, via a YMS 204.

At block 502, similar to FIG. 5, a vehicle 112 is detected.

At block 504, similar to FIG. 5, the automation system 202 processes images from the imaging devices 103 to determine one or more characteristics associated with the vehicle 112.

At block 602, information (e.g., a driver's license, bill of lading, etc.) is received at the third-party input terminal 106.

At block 604, the third-party system engages with the automation system 202. Engaging can include requesting the generation of a check-in event, where the request includes the information received in block 602.

At block 606, the automation system 202 determines whether automated check-in can occur, similar to block 509.

At block 510, the automated check-in can be unsuccessful, and additional information may be required.

At block 608, an appointment query is created in a YMS 204.

At block 609, the assigned destination 118 is retrieved. For example, the destination assignment process 518 can be completed by the AI module 210, and the YMS 204 can initiate an asset query with the AI module 210 to retrieve the assigned destination 118. In some embodiments, the destination assignment process 518 can be completed by the YMS 204, and the AI module 210 can retrieve the assigned destination (e.g., via the designated API).

At block 610, the guidance data file can be displayed (e.g., on the input terminal 106), or transmitted. For example, transmitting can include the guidance data file can be a data file that is provided to a user 107 mobile device, or to specialized devices associated with the vehicle 112.

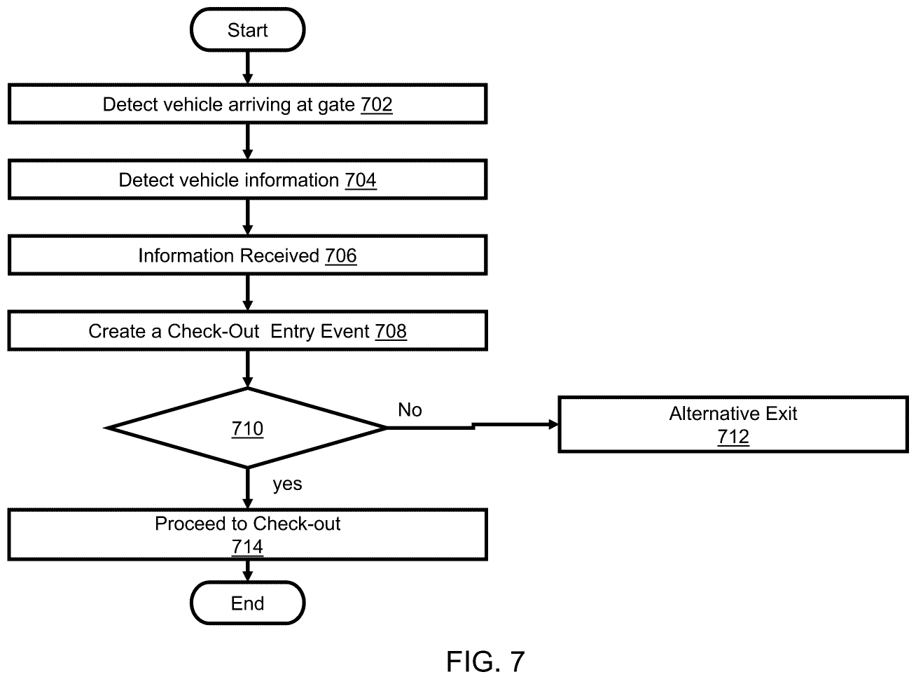

FIG. 7 provides a flow diagram of yet another example method for operating a gate. In the shown example, the flow diagram shows operations to operate an outbound gate using both the automated check-in system described herein.

At block 702, the vehicle arriving at the outbound gate is detected or determined. For example, the imaging devices 102 can detect a vehicle 112 arriving at the outbound gate, the detection of the vehicle 112 can be triggered based on detection via a sensor (e.g., sensor 114), based on an entry in the Automation system 202 or the YMS (e.g., vehicle is expected to be at the outbound gate once the inventory is confirmed to be unloaded), etc.

At block 704, the information on the vehicle 112 is detected, similar to block 504. In example embodiments, the detection of block 704 is different than that of block 504, as the automation system 202 is configured for the specific fields of via available at the outbound gate.

At block 706, the information of block 704 is received, similar to block 506.

At block 708, a check-in event is generated, similar to block 508.

At block 710, the automation system 202 determines whether an automated check-out event can occur. For example, the automation system 202 can be trained to determine whether the information of the vehicle matches the information provided upon entry, whether the vehicle 112 has suffered more than a threshold amount of damage, whether additional users 107 are in the vehicle, etc.

In response to determining that automated check-out is possible, block 714 can include operating the access control device 104a to open and allow the vehicle 112 to exit.

At block 712, in response to the automation system 202 determining that automated checkout is unavailable, additional information is required, or an alternative check-out process is required. This can include a visual inspection of the vehicle 112, identification of the user 107, etc.

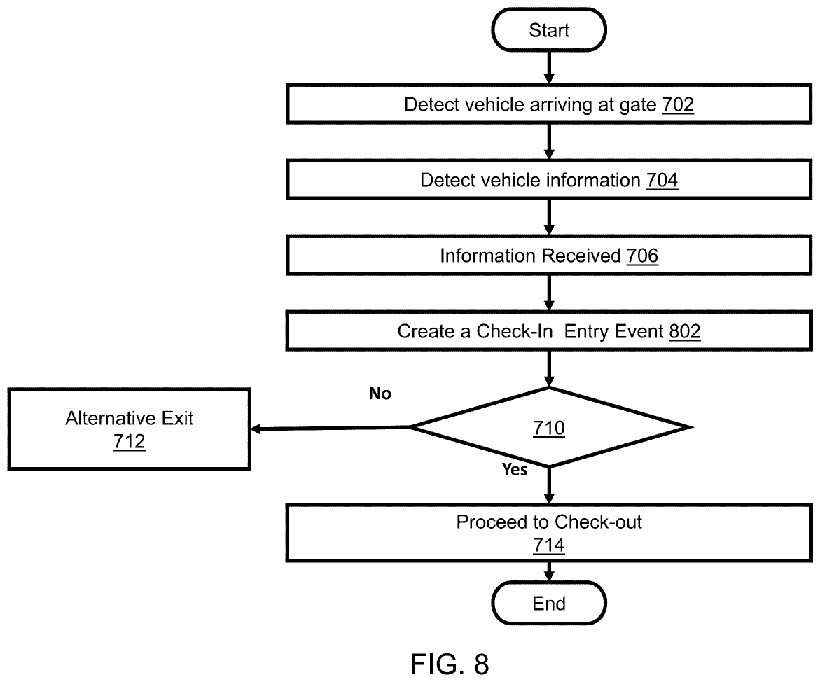

FIG. 8 provides a flow diagram of yet another example method for operating an outbound gate.

In the shown flow, at block 802, similar to block 604, a check-out event is created at least in part by a third party YMS 204 communicating with the automation system 202.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the Automation system 202 related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order or in parallel, or steps may be added, deleted, or modified.

Although the above principles have been described with reference to certain specific examples, various modifications thereof will be apparent to those skilled in the art as having regard to the appended claims in view of the specification as a whole.

1. A method for automating vehicle ingress or egress, comprising:
receiving a plurality of images of a vehicle from one or more imaging devices;
processing the plurality of images with an automation system by:
with a machine vision model of the automation system, determining one or more properties associated with the vehicle;
receiving a data file based on an interaction between a driver and an input terminal in communication with the automation system;
processing the data file with the automation system by:
generating a check-in event;
with a machine learning model, validating the check-in event based at least in part on the one or more properties associated with the vehicle; and
determining a destination of the vehicle based on the validated check-in event; and
generating a guidance data file that comprises path guidance from a location of the vehicle to the determined destination, the guidance data file generating visual elements to indicate the destination once executed by a device associated with the vehicle.

2. The method of claim 1, comprising, in response to validating the check-in event, instructing a gate to permit entry or egress to the vehicle.

3. The method of claim 1, comprising:
with the machine vision model, generating a three-dimensional model of the vehicle;
receiving a second set of images from the one or more imaging devices;
with the machine vision model, generating a second three-dimensional model of the vehicle based on the second set of images; and
generating an estimate of damage to the vehicle incurred for a duration between the plurality of images and the second set of images.

4. The method of claim 1, wherein the guidance data file comprises generated visual elements that overlay onto existing mapping applications.

5. The method of claim 1, wherein the data file comprises an image of identification of the driver, the method comprising:
with a machine vision model of the automation system, determining one or more properties of the identification from the image, and
wherein the validation of the check-in event is at least in part based on the determined one or more properties of the identification.

6. The method of claim 1, comprising, with an interface of the automation system, retrieving existing information related to the vehicle or driver from a yard management system.

7. The method of claim 6, wherein the destination is determined based on the existing information.

8. The method of claim 1, comprising:
with the machine vision model, generating a three-dimensional model of the vehicle; and
determining one or more properties associated with the vehicle based on the three-dimensional model of the vehicle.

9. The method of claim 1, comprising:
receiving a plurality of images for a plurality of vehicles; and
processing the plurality of images with the automation system to determine optimal paths for the plurality of vehicles to respective destinations or to gates for ingress or egress.

10. The method of claim 1, comprising:
in response to not receiving input from a sensor used to detect vehicles, stopping processing of the plurality of images by the automation system.

11. The method of claim 1, comprising:
receiving a second set of images of the vehicle from the one or more imaging devices;
with the machine vision model, at least in part determining a presence of the vehicle in the second set of images;
determining a duration the vehicle spent inside a region based on the plurality of images and the second set of images; and
generating an invoice based on the determined duration.

12. A system for automating vehicle ingress or egress, the system comprising:
one or more imaging devices;
a processor; and
a memory, in communication with the processor, the memory storing computer executable instructions that cause the processor to:
receive a plurality of images of a vehicle from the one or more imaging devices;
processing the plurality of images with an automation system to:
with a machine vision model of the automation system, determine one or more properties associated with the vehicle;
receive a data file based on an interaction between a driver and an input terminal in communication with the automation system;
process the data file with the automation system to:
generate a check-in event;
with a machine learning model, validate the check-in event based at least in part on the one or more properties associated with the vehicle; and
determine a destination of the vehicle based on the validated check-in event; and
generate a guidance data file that comprises path guidance from a location of the vehicle to the determined destination, the guidance data file generating visual elements to indicate the destination once executed by a device associated with the vehicle.

13. The system of claim 12, wherein the computer executable instructions cause the processor to:
in response to validating the check-in event, instruct a gate to permit entry or egress to the vehicle.

14. The system of claim 12, wherein the computer executable instructions cause the processor to:
with the machine vision model, generate a three-dimensional model of the vehicle;
receive a second set of images from the one or more imaging devices;
with the machine vision model, generate a second three-dimensional model of the vehicle based on the second set of images; and
generate an estimate of damage to the vehicle incurred for a duration between the plurality of images and the second set of images.

15. The system of claim 12, wherein the guidance data file comprises generated visual elements that overlay onto existing mapping applications.

16. The system of claim 12, wherein the data file comprises an image of identification of the driver, the computer executable instructions causing the processor to:
with a machine vision model of the automation system, determine one or more properties of the identification from the image, and
wherein the validation of the check-in event is at least in part based on the determined one or more properties of the identification.

17. The system of claim 12, wherein the computer executable instructions cause the processor to, with an interface of the automation system, retrieve existing information related to the vehicle or driver from a yard management system.

18. The system of claim 17, wherein the destination is determined based on the existing information.

19. The system of claim 12, wherein the computer executable instructions cause the processor to:
with the machine vision model, generate a three-dimensional model of the vehicle; and
determine one or more properties associated with the vehicle based on the three-dimensional model of the vehicle.

20. A computer readable medium comprising computer executable instructions, the computer readable medium, when executed by a processor, causing the processor to:
receive a plurality of images of a vehicle from one or more imaging devices;
processing the plurality of images with an automation system to:
with a machine vision model of the automation system, determine one or more properties associated with the vehicle;
receive a data file based on an interaction between a driver and an input terminal in communication with the automation system;
process the data file with the automation system to:
generate a check-in event;
with a machine learning model, validate the check-in event based at least in part on the one or more properties associated with the vehicle; and
determine a destination of the vehicle based on the validated check-in event; and
generate a guidance data file that comprises path guidance from a location of the vehicle to the determined destination, the guidance data file generating visual elements to indicate the destination once executed by a device associated with the vehicle.
